(19) United States
(12) Patent Application Publication
(10) Pub. No.: US 2026/0184362 A1
(43) Pub. Date: Jul. 2, 2026

(54) BABY STROLLER

(71) Applicant: Yongchun Tu, Xiaogan (CN)

(72) Inventor: Yongchun Tu, Xiaogan (CN)

(21) Appl. No.: 19/220,185

(22) Filed: May 28, 2025

(30) Foreign Application Priority Data
Dec. 26, 2024 (CN) 202423229273.1

(51) Int. Cl. B62B 7/06

(52) U.S. Cl. CPC B62B 7/066; B62B 2205/00

(57) ABSTRACT

A baby stroller is provided, which includes a side frame and a bottom frame. There are two sets of side frames and two sets of bottom frames, and a lower part of each set of side frames is rotatably provided with one set of bottom frames. The two sets of bottom frames are connected by a folding mechanism. The baby stroller of this application includes two sets of side frames and two sets of bottom frames. The two sets of bottom frames are connected by the folding mechanism, and the folding of the stroller can be completed by lifting the folding mechanism. The operation is simple, convenient, and labor-saving, and a folded space is small, rendering it easy to transport and store.

### CROSS-REFERENCE TO RELATED APPLICATIONS

This application claims priority to Chinese Patent Application No. 202423229273.1, filed on Dec. 26, 2024, which is hereby incorporated by reference in its entirety.

### TECHNICAL FIELD

The present disclosure relates to the field of stroller technologies, and in particular, to a baby stroller.

### BACKGROUND

With the development of the economy and the advancement of technology, people's demand for baby products has become diversified. As a traditional baby product, baby strollers provide convenience for people's travel or outdoor activities and have a wide market demand.

However, folding ways of existing baby strollers are relatively complex, difficult for a user to operate, and a folded volume is relatively large.

### SUMMARY

In order to compensate for shortcomings of existing technology, the present disclosure provides a baby stroller.

To achieve the above objectives, the present disclosure adopts the following technical solutions.

A baby stroller, including a side frame and a bottom frame, there are two sets of side frames and two sets of bottom frames; a lower of each set of side frames is rotatably provided with one set of bottom frames, and the two sets of bottom frames are connected by a folding mechanism.

In some embodiments of the present disclosure, the side frames include a handle and fixed rods, the handle is hinged at tops of the fixed rods through a hinge seat, bottoms of the fixed rods are rotatably connected to the bottom frames through a connection seat, and the fixed rods are fixedly connected to each other through a crossbeam.

In some embodiments of the present disclosure, uppers of the side frames are rotatably connected to a side connection rod through the connection seat.

In some embodiments of the present disclosure, the connection seat includes a fixing part and a hinge part, the fixing part is provided with a fixing hole, the hinge part is provided with a hinge hole; a bottom of the hinge part is provided with a limit support plate.

In some embodiments of the present disclosure, a light rope or a connection rod is provided between the side frames and the bottom frames; two ends of the light rope are fixedly connected to the side frames and the bottom frames respectively; a lower of the connection rod is hinged to the bottom frames, and an upper of the connection rod is provided on the fixed rods of the side frames through a sliding seat.

In some embodiments of the present disclosure, the bottom frames are rectangular frame structures and include bottom side rods and a bottom horizontal rod connected between the bottom side rods, and one wheel is provided at each corner of the bottom frames.

In some embodiments of the present disclosure, the folding mechanism includes a movable clamp pin and a clamp pin seat; the movable clamp pin is provided in the bottom side rods and includes a clamp pin body; the clamp pin body is fixedly connected to the bottom side rods; the clamp pin body is provided with a return spring and a clamp column; one end of the clamp column is provided with a slope; the clamp pin seat is hinged to the bottom side rods, and a folding connection seat is connected to a top of the clamp pin seat through a pull rod; the folding connection seat is hinged to the side connection rods through the hinge seat; the clamp pin seat is provided with two symmetrically arranged clamp slots that cooperate with the movable clamp pin; a clamp pin top block is provided below the clamp slots in the clamp pin seat, and the clamp pin top block is provided with a slope that matches the clamp column; the clamp pin top block is connected to a pull rope, and the pull rope is provided in the pull rod; the pull rod is provided with a pull handle connected to the pull rope.

In some embodiments of the present disclosure, two clamp pin seats are connected by a folding central axis.

In some embodiments of the present disclosure, a top of the clamp pin top block is provided with a reset spring.

In some embodiments of the present disclosure, an upper of the pull rod is provided with a through hole along a length direction, and the pull rod is connected to the pull handle through the through hole.

Due to the above structure, the beneficial effects of the present disclosure are as follows.

The baby stroller of this application includes two sets of side frames and two sets of bottom frames. The two sets of bottom frames are connected by a folding mechanism, and the folding of the stroller can be completed by lifting the folding mechanism. The operation is simple, convenient, and labor-saving, and a folded space is small, rendering it easy to transport and store.

### BRIEF DESCRIPTION OF DRAWINGS

In order to provide a clearer explanation of the technical solution in the embodiments of the present disclosure, a brief introduction will be given to the accompanying drawings required for the description of the embodiments.

FIG. 1 is a schematic structural diagram of an unfolded state of the present disclosure.

FIG. 2 is a schematic structural diagram of a folding process of the present disclosure.

FIG. 3 is a schematic structural diagram of a folded state of the present disclosure.

FIG. 4 is a schematic structural diagram of a connection seat of the present disclosure.

FIG. 5 is a schematic structural diagram of a folding mechanism of the present disclosure.

FIG. 6 is a sectional view of the folding mechanism of the present disclosure.

### DESCRIPTION OF EMBODIMENTS

The following will provide a clear and complete description of the technical solution of the present disclosure in combination with the accompanying drawings. Based on the embodiments in the present disclosure, all other embodiments obtained by those skilled in the art without creative work are within the protection scope of the present disclosure.

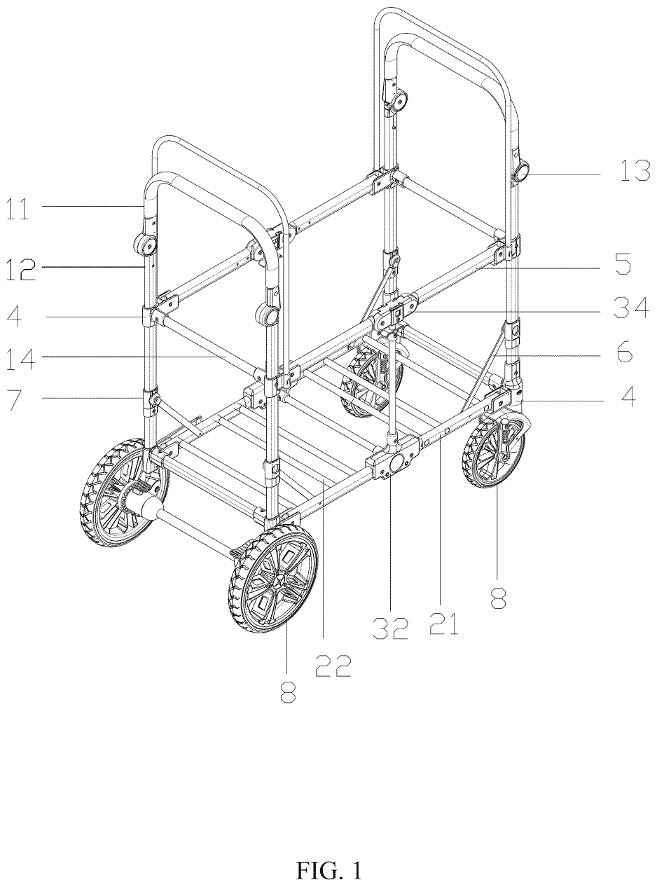

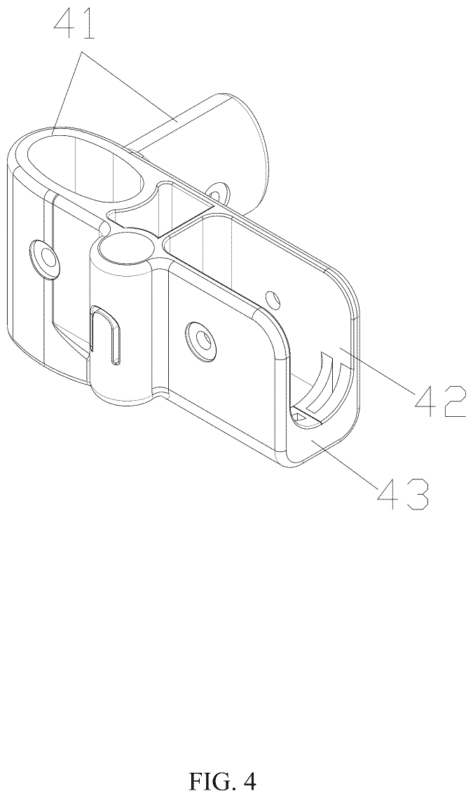

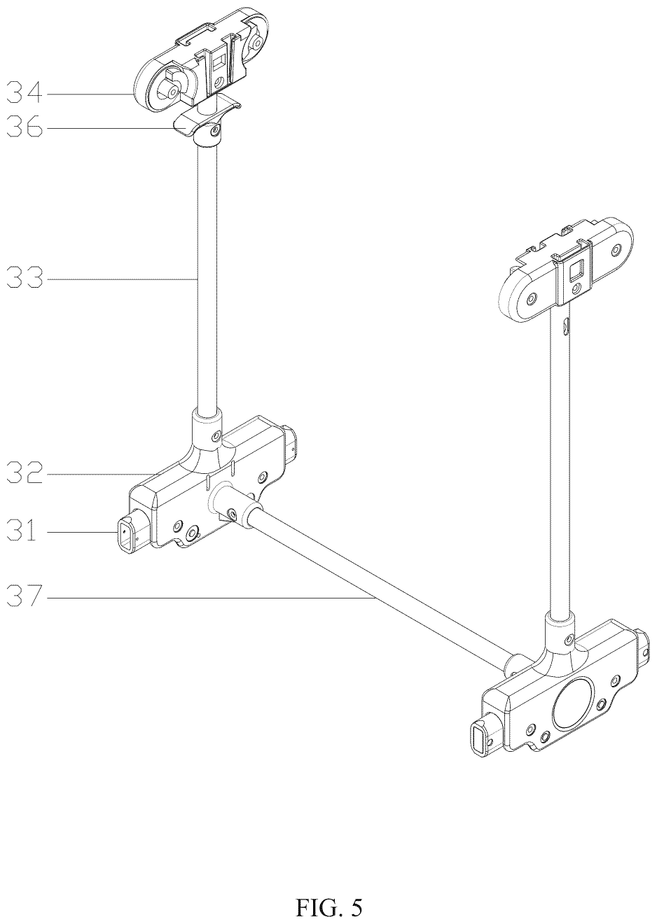

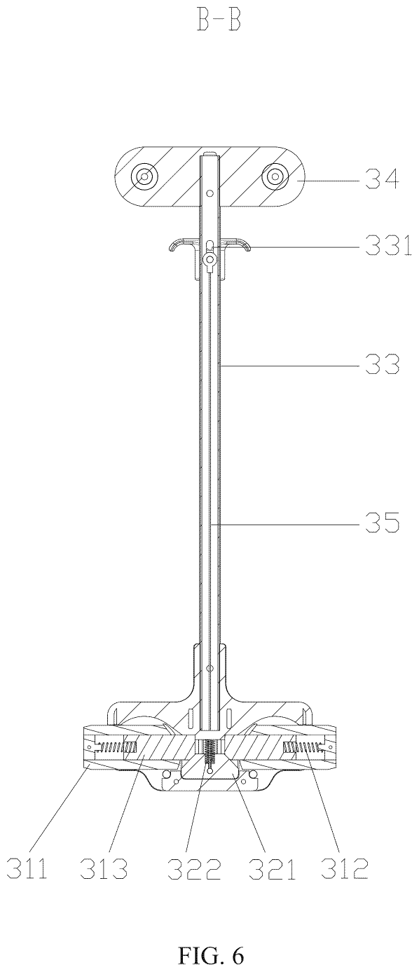

As shown in FIGS. 1 to 6, an embodiment provides a baby stroller, which includes a side frame 1 and a bottom frame 2. There are two sets of side frames 1 and two sets of bottom frames 2; a lower of each set of side frames 1 is rotatably provided with one set of bottom frames 2. The two sets of bottom frames 2 are connected by a folding mechanism 3.

In this embodiment, the side frames 1 include a handle 11 and fixed rods 12. The handle 11 is hinged to tops of the fixed rods 12 through a hinge seat 13, and bottoms of the fixed rods 12 are rotatably connected to the bottom frames 2 through a connection seat 4. The fixed rods 12 are fixedly connected to each other through a crossbeam 14. Uppers of the side frames 1 are rotatably connected to a side connection rod 5 through the connection seat 4. The connection seat 4 includes a fixing part 41 and a hinge part 42. The fixing part 41 is provided with a fixing hole, and the hinge part 42 is provided with a hinge hole. A bottom of the hinge part 42 is provided with a limit support plate 43, and the limit support plate 43 serves as a support point to prevent the side connection rod 5 and pipe fittings of the bottom frames 2 connected to it from downward.

In this embodiment, a light rope or a connection rod 6 is provided between the side frames 1 and the bottom frames 2. If the light rope is a soft and foldable rope, its two ends are fixedly connected to the fixed rods 12 of the side frames 1 and bottom side rods 21 of the bottom frames 2. If it is a connection rod, a lower of the connection rod 6 is hinged to the bottom frames 2, and an upper of the connection rod 6 is provided on the fixed rods 12 of the side frames 1 through a sliding seat 7. Both the light rope and the connection rod 6 can hold pipe fittings of the bottom frames 2, thereby preventing them from going down, thereby improving structural strength of a folding stroller rack.

In this embodiment, the bottom frames 2 are rectangular frame structures and include bottom side rods 21 and a bottom horizontal rod 22 connected between the bottom side rods 21. One wheel 8 is provided at each four corner of the bottom frames 2.

In this embodiment, the folding mechanism includes a movable clamp pin 31 and a clamp pin seat 32. The movable clamp pin 31 is provided in the bottom side rods 21 and includes a clamp pin body 311, and the clamp pin body 311 is fixedly connected to the bottom side rods 21. The clamp pin body 311 is provided with a return spring 312 and a clamp column 313, one end of the clamp column 313 is provided with a slope. The clamp pin seat 32 is hinged to the bottom side rods 21, and two clamp pin seats 32 are connected by a folding central axis 37. Above the clamp pin seat 32, there is a folding connection seat 34 connected by a pull rod 33. The folding connection seat 34 is hinged to the side connection rod 5 through the hinge seat. The clamp pin seat 32 is provided with two symmetrically arranged clamp slots that cooperate with the movable clamp pin 31. The clamp pin seat 32 is provided with a clamp pin top block 321 located below the clamp slots, and the clamp pin top block 321 is provided with a slope that matches the clamp column 313. A top of the clamp pin top block 321 is provided with a reset spring 322. The clamp pin top block 321 is connected to a pull rope 35, and the pull rope 35 is provided in the pull rod 33. The pull rope 35 is connected to a pull handle 36 connected to the pull rope 35. The pull handle 36 is provided with a through hole 331 on an upper of the pull rod 33 along a length direction, and the pull rod 33 is slidably connected to the pull handle 36 through the through hole 331.

The working principle of the above structure is as follows.

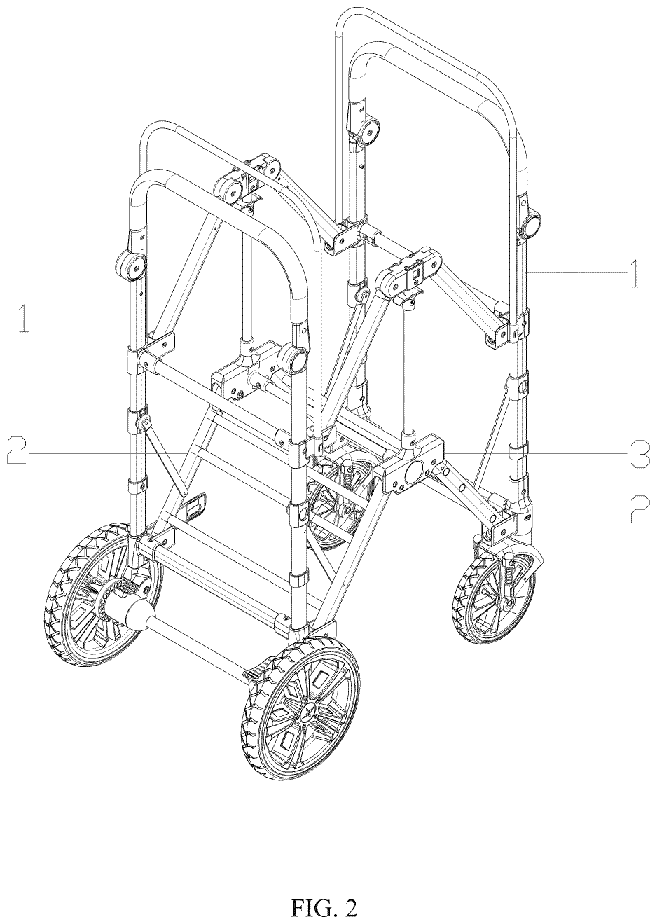

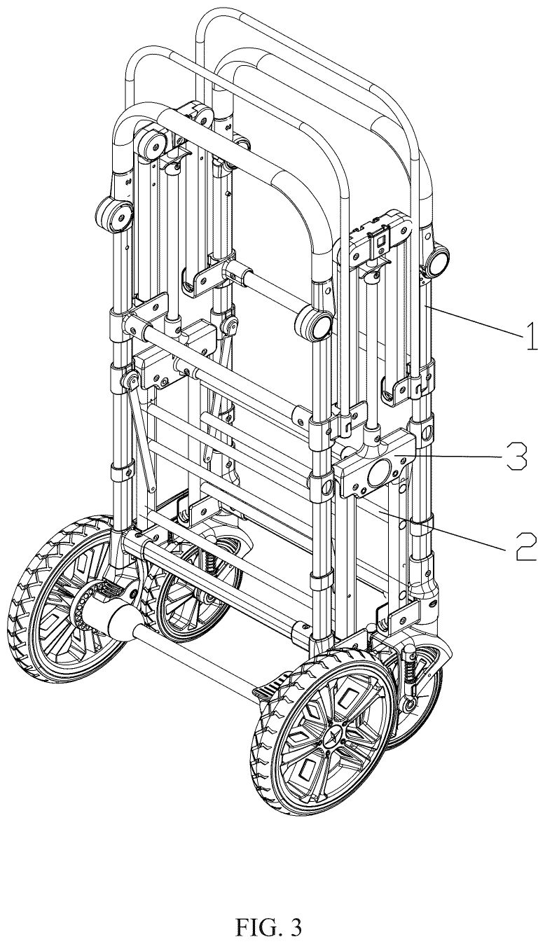

When folding is needed, the pull handle 36 is pulled upwards. The pull handle 36 drives the clamp pin top block 321 to move upwards through the pull rope 35. The clamp column 313 of the movable clamp pin 31 moves left and right inside the clamp pin body 311 under a push of the clamp pin top block 321, and finally disengages from the clamp slots of the clamp pin seat 32, thereby releasing a locking of the bottom frames 2. At this time, the folding mechanism 3 can be pulled upwards, as shown in FIG. 2. The folding mechanism 3 drives the side connection rod 5 and the bottom frames 2 connected to it to rotate upwards, and the sliding seat 7 slides upwards. Finally, it is folded to a state shown in FIG. 3. After releasing the pull handle 36, the clamp pin top block 321 can be reset again under an action of the reset spring 322.

When it needs to be unfolded again, the folding mechanism 3 is pressed downwards to drive the side connection rod 5 and the bottom frames 2 connected to it to rotate downwards, and at the same time, the sliding seat 7 slides downwards. When the two sets of bottom frames 2 are pushed to the horizontal, the clamp column 313 inside the bottom side rods 21 can be re inserted into the clamp slots of the clamp pin seat 32 under the force of the return spring 312, so that it cannot be lifted upwards and the unfolding is completed.

The above are only preferred embodiments of the present disclosure and are not intended to limit the present disclosure. For those skilled in the art, the present disclosure may have various modifications and variations. Any modifications, equivalent substitutions, improvements, etc. made within the spirit and principles of the present disclosure shall be included in the protection scope of the present disclosure.

What is claimed is:

1. A baby stroller, comprising a side frame and a bottom frame, there are two sets of side frames and two sets of bottom frames;
a lower of each set of side frames is rotatably provided with one set of bottom frames, and the two sets of bottom frames are connected by a folding mechanism.

2. The baby stroller according to claim 1, wherein the side frames comprise a handle and fixed rods, the handle is hinged at tops of the fixed rods through a hinge seat, bottoms of the fixed rods are rotatably connected to the bottom frames through a connection seat, and the fixed rods are fixedly connected to each other through a crossbeam.

3. The baby stroller according to claim 1, wherein uppers of the side frames are rotatably connected to a side connection rod through the connection seat.

4. The baby stroller according to claim 2, wherein the connection seat comprises a fixing part and a hinge part, the fixing part is provided with a fixing hole, the hinge part is provided with a hinge hole;
a bottom of the hinge part is provided with a limit support plate.

5. The baby stroller according to claim 1, wherein a light rope or a connection rod is provided between the side frames and the bottom frames;
two ends of the light rope are fixedly connected to the side frames and the bottom frames respectively;
a lower of the connection rod is hinged to the bottom frames, and an upper of the connection rod is provided on the fixed rods of the side frames through a sliding seat.

6. The baby stroller according to claim 1, wherein the bottom frames are rectangular frame structures and comprise bottom side rods and bottom horizontal rod connected between the bottom side rods, and one wheel is provided at each corner of the bottom frames.

7. The baby stroller according to claim 1, wherein the folding mechanism comprises a movable clamp pin and a clamp pin seat;
the movable clamp pin is provided in the bottom side rods and comprises a clamp pin body;
the clamp pin body is fixedly connected to the bottom side rods;
the clamp pin body is provided with a return spring and a clamp column;
one end of the clamp column is provided with a slope;
the clamp pin seat is hinged to the bottom side rods, and a folding connection seat is connected to a top of the clamp pin seat through a pull rod;
the folding connection seat is hinged to the side connection rods through the hinge seat;
the clamp pin seat is provided with two symmetrically arranged clamp slots that cooperate with the movable clamp pin;
a clamp pin top block is provided below the clamp slots in the clamp pin seat, and the clamp pin top block is provided with a slope that matches the clamp column;
the clamp pin top block is connected to a pull rope, and the pull rope is provided in the pull rod;
the pull rod is provided with a pull handle connected to the pull rope.

8. The baby stroller according to claim 7, wherein two clamp pin seats are connected by a folding central axis.

9. The baby stroller according to claim 7, wherein a top of the clamp pin top block is provided with a reset spring.

10. The baby stroller according to claim 7, wherein an upper of the pull rod is provided with a through hole along a length direction, and the pull rod is connected to the pull handle through the through hole.
